(19) United States
(12) Patent Application Publication
(10) Pub. No.: US 2024/0131955 A1
(43) Pub. Date: Apr. 25, 2024

(54) METHOD AND SYSTEM FOR CONTROLLING BATTERY SWAPPING OF VEHICLE, AND VEHICLE

(71) Applicant: BYD COMPANY LIMITED, Shenzhen (CN)

(72) Inventors: Hao LU, Shenzhen (CN); Zhicheng TAN, Shenzhen (CN); Hongtao SHE, Shenzhen (CN); Mingyang GUO, Shenzhen (CN); Keqi ZHANG, Shenzhen (CN)

(73) Assignee: BYD COMPANY LIMITED, Shenzhen (CN)

(21) Appl. No.: 18/395,447

(22) Filed: Dec. 22, 2023

Related U.S. Application Data
(63) Continuation of application No. PCT/CN2022/103847, filed on Jul. 5, 2022.

(30) Foreign Application Priority Data
Sep. 29, 2021 (CN) 202111167747.2

(51) Int. Cl. B60L 53/80; B60L 53/60

(52) U.S. Cl. CPC B60L 53/80; B60L 53/60

(57) ABSTRACT

A method and a system for controlling battery swapping of a vehicle and a vehicle are provided. The method includes: receiving, by a vehicle control unit (VCU), a battery swapping instruction, and transmitting the battery swapping instruction to a battery manager when the vehicle is in a high-voltage power-on state; transmitting, by the battery manager, an enable instruction to a direct current (DC) charger assembly in response to the received battery swapping instruction; and performing, by the DC charger assembly, a starting operation in response to the enable instruction, so as to provide a power supply voltage to a vehicle load after an electrical connection between a power battery pack and a high-voltage circuit of the vehicle is cut off during battery swapping of the vehicle.

### CROSS-REFERENCE TO RELATED APPLICATIONS

The present disclosure is a bypass continuation application of PCT International Application No. PCT/CN2022/103847, filed on Jul. 5, 2022, which claims priority to Chinese Patent Application No. 202111167747.2 filed on Sep. 30, 2021. The entire contents of the above-referenced applications are incorporated herein by reference.

### FIELD

The present disclosure generally relates to a method and a system for controlling battery swapping of a vehicle, and a vehicle.

### BACKGROUND

Currently, in order to improve safety during battery swapping of a vehicle, a vehicle control unit (VCU) controls a battery manager system to cut off a high-voltage relay, so that a battery swapping execution apparatus performs a battery swapping operation after the battery manager system cuts off the high-voltage relay, to ensure safety protection of a battery box and performance of the vehicle and safety of the battery swapping operation.

Currently, the high-voltage power supply is cut off, and then the operation of battery swapping is performed, which makes a high-voltage load of the vehicle operate intermittently, resulting in a failure of some functions of the vehicle and poor passenger experience.

### SUMMARY

In view of the above defects or disadvantages in the related art, a method and a system for controlling battery swapping of a vehicle, and a vehicle are desired.

According to a first aspect, an embodiment of the present disclosure provides a method for controlling battery swapping of a vehicle. The vehicle includes a vehicle control unit (VCU), a power battery pack, a vehicle load, and a battery manager. The power battery pack is configured to supply power to the vehicle load.

The method includes the following steps.

The VCU receives a battery swapping instruction and transmitting the battery swapping instruction to the battery manager when the vehicle is in a high-voltage power-on state.

The battery manager transmits an enable instruction to a DC charger assembly in response to the battery swapping instruction, the DC charger assembly is arranged on the ground and configured to communicate with the battery manager.

The DC charger assembly performs a starting operation in response to the enable instruction.

The battery manager cuts off an electrical connection between the power battery pack and a high-voltage circuit of the vehicle, and the DC charger assembly provides a power supply voltage to the vehicle load.

According to a second aspect, an embodiment of the present disclosure provides a battery swapping system. The system includes a VCU, a DC charger assembly, a power battery pack, a vehicle load, and a battery manager. The power battery pack is configured to supply power to the vehicle load.

The VCU is configured to receive a battery swapping instruction and transmit the battery swapping instruction to the battery manager when the vehicle is in a high-voltage power-on state.

The battery manager is configured to receive the battery swapping instruction received by the VCU, and transmit an enable instruction to the DC charger assembly in response to the battery swapping instruction; the DC charger assembly is arranged on the ground and configured to communicate with the battery manager.

The DC charger assembly is configured to perform a starting operation in response to the enable instruction.

The battery manager is configured to cut off an electrical connection between the power battery pack and a high-voltage circuit of the vehicle. The DC charger assembly is configured to provide a power supply voltage to the vehicle load.

According to a third aspect, an embodiment of the present disclosure provides a vehicle. The vehicle is configured with the system for controlling battery swapping according to the second aspect. The vehicle is configured to perform the method for controlling battery swapping of a vehicle according to the first aspect during swapping of the power battery pack in a high-voltage power-on state.

### BRIEF DESCRIPTION OF THE DRAWINGS

Other features, objectives, and advantages of the present disclosure become more apparent by reading detailed description of the following non-limiting embodiments made with reference to the drawings.

FIG. 1 is a schematic diagram of a topology of a vehicle high voltage according to an embodiment of the present disclosure.

FIG. 2 is a schematic diagram of a topology of a battery of a vehicle requiring battery swapping according to an embodiment of the present disclosure.

FIG. 3 is a schematic diagram of a topology of a maintenance switch of a vehicle requiring battery according to an embodiment of the present disclosure.

FIG. 4 is a schematic diagram of a topology of a high-voltage distribution box of a vehicle requiring battery according to an embodiment of the present disclosure.

FIG. 5 is a schematic diagram of a network communication structure of a vehicle requiring battery according to an embodiment of the present disclosure.

FIG. 6 is a schematic flowchart of a method for controlling battery swapping of a vehicle according to an embodiment of the present disclosure.

FIG. 7 is a schematic flowchart of a method for controlling battery swapping of a vehicle according to some embodiments of the present disclosure.

FIG. 8 is a schematic flowchart of a method for controlling battery swapping of a vehicle according to some embodiments of the present disclosure.

FIG. 9 is a schematic flowchart of a method for controlling battery swapping of a vehicle according to some embodiments of the present disclosure.

FIG. 10 is a schematic flowchart of a method for controlling battery swapping of a vehicle according to some embodiments of the present disclosure.

FIG. 11 is a schematic structural diagram of a computer of a processing device according to an embodiment of the present disclosure.

### DESCRIPTION OF REFERENCE NUMERALS

BATS—Power battery pack, LH1, LH—Current transformer, KM1—Positive discharge electrode contactor of a power battery pack, KM2—Negative discharge electrode contactor of a power battery pack, Cs—Maintenance switch assembly, KM3—Positive discharge electrode contactor of a main circuit, KM4—Negative discharge electrode contactor of a main circuit, QS—Disconnecting switch, FU2—Charging fuse, KM5—Charging contactor, KM6—Negative charge electrode contactor, KM7—DC pre-contactor, KM8—DC contactor, KM01—Main contactor, KM02—Main precharging contactor, FU3—Main fuse, FU4-DC—DC fuse, FU5—PTC fuse, FU6—Air conditioning fuse, FU7—Air compressor fuse, S—Leakage sensor, R—Precharging resistor, BMM—Battery manager, CDC-charge—Direct current charging assembly, CHP—Charging bow, Ccon—Motor control unit assembly, CDC-DC-DC—DC converter assembly, CPTC—PTC assembly, CACE—Air conditioner assembly, Ccom—Air compressor assembly.

### DETAILED DESCRIPTION

The present disclosure is described in further details below with reference to the drawings and the embodiments. It may be understood that the specific embodiments described herein are used for explaining but not limiting a related present disclosure. Further, it is to be understood that for ease of description, only parts relevant to the present disclosure are shown in the drawings.

It should be noted that the embodiments in the present disclosure and features in the embodiments may be combined with each other in case of no conflict. The present disclosure is described in detail below with reference to the drawings and the embodiments.

It may be understood that during an operation of a rail transit vehicle, such as a light rail or a subway, a fixed operation route is configured, and a charging station is arranged on an operation route to charge a power battery in the vehicle. Alternatively, during an operation of an electric vehicle or a hybrid vehicle, such as a public transport vehicle, the power battery in the vehicle is also requires to be charged at the configured charging station. In the above charging process, a lot of time is wasted.

Currently, in order to improve operational efficiency of the vehicle and improve safety of the power battery, a power battery pack in the rail transit vehicle or the electric vehicle is centrally charged through a built battery swapping station, so that during the operation of the vehicle, when the power in the power battery is insufficient, the power battery having insufficient power can be swapped with the power battery provided by the battery swapping station after charging.

In an embodiment of the present disclosure, based on ensuring safe connection between a battery box and a body during battery swapping, and realizing safe and reliable battery swapping operation, a normal operation of the remaining loads in the vehicle is still maintained during battery swapping to improve user experience.

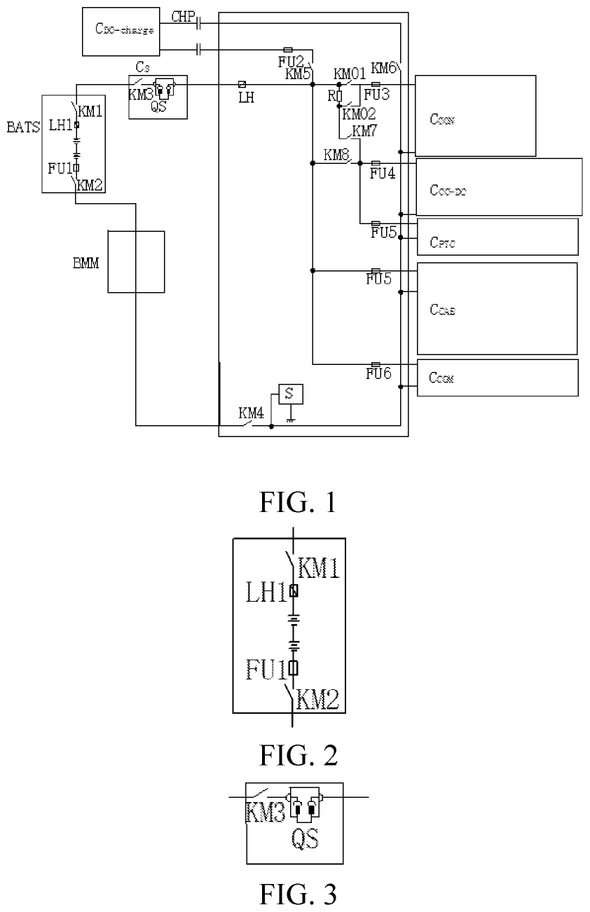

FIG. 1 is a schematic structural diagram of a system for controlling battery swapping of a vehicle according to an embodiment of the present disclosure. As shown in FIG. 1, the system may include a power battery pack, a maintenance switch assembly, a high-voltage distribution box, a direct current (DC) charger assembly, a charging bow, a current collector, a motor controller, a DC-DC converter assembly, a heater assembly, an air conditioner assembly, and an air compressor assembly.

As shown in FIG. 2, the power battery pack includes a positive discharge electrode contactor of a power battery pack KM1, and a negative discharge electrode contactor of a power battery pack KM2. In other words, opening and closing of the positive discharge electrode contactor of a power battery pack KM1 and the negative discharge electrode contactor of a power battery pack KM2 are controlled by the battery manager, so that the power battery pack and the high-voltage circuit of the vehicle are disconnected and connected.

In addition, as shown in FIG. 3, the high-voltage circuit structure may further include a positive discharge electrode contactor KM3 of a main circuit and a negative discharge electrode contactor KM4 of a main circuit. The positive discharge electrode contactor KM3 of the main circuit is arranged in the maintenance switch assembly, and the negative discharge electrode contactor KM4 of the main circuit is arranged in the high-voltage distribution box.

In practice, the vehicle can be powered on by opening and closing the positive discharge electrode contactor KM3 of the main circuit and the negative discharge electrode contactor KM4 of the main circuit.

The heater assembly, the air conditioner assembly, the air compressor assembly, and the like are configured as the load assembly of the vehicle, that is, the vehicle load.

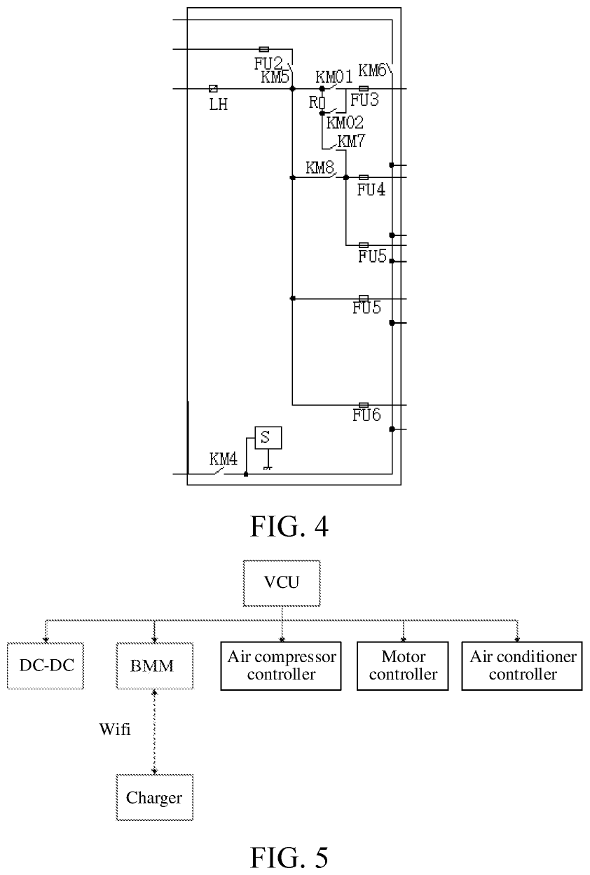

FIG. 4 is a circuit topology of a high-voltage distribution box in a vehicle according to an embodiment of the present disclosure. As shown in FIG. 4, circuit fuses and switch devices for vehicle loads are arranged in the high-voltage distribution box such as including the negative discharge electrode contactor KM4 of the main circuit, a charging contactor, and a negative charge electrode contactor.

The battery manager (Battery Management, BMM) may specifically perform control the KM1, the KM2, the KM3, the KM4, the charging contactor, and the negative charge electrode contactor to close and open.

As shown in FIG. 5, in an embodiment of the present disclosure, the vehicle control unit (VCU) in the above circuit structure can communicate with devices such as the DC-DC converter assembly, the battery manager, the motor control unit, the air conditioner control unit in the air conditioner assembly, and the control unit in the air compressor assembly to realize control of each device.

The DC charger assembly in this system is generally configured as a ground device and may be electrically connected to the battery manager for charging. Specifically, the connection may be performed through a wired connection or a wireless connection, such as a wireless connection through Wi-Fi.

The DC charger assembly has a constant voltage output function. Therefore, in a normal power-on mode of the vehicle, the DC charger assembly does not output. When a battery swapping mode is entered, the charging bow may be controlled to perform bow lowering, so that the DC charger assembly is connected to an on-board current collector through the charging bow and the charging circuit of the vehicle is closed and the constant voltage output is maintained. In addition, after battery swapping is completed, the charging bow may be controlled to perform bow raising to disconnect the charging circuit of the vehicle.

In other words, in an embodiment of the present disclosure, to ensure safe connection between the battery box and the body during battery swapping, based on realizing safe and reliable battery swapping operation, the charging bow is controlled to perform bow lowering and connected to the on-board current collector by using the DC charger assembly, so that the charging circuit of the vehicle is closed to provide a constant voltage to the vehicle load as a constant voltage source. Therefore, after the high-voltage contactor is cut off during battery swapping of the vehicle, the normal power supply of the vehicle load is still maintained, and the power battery and the DC charger assembly are seamlessly connected to the power supply of the vehicle load to improve user experience.

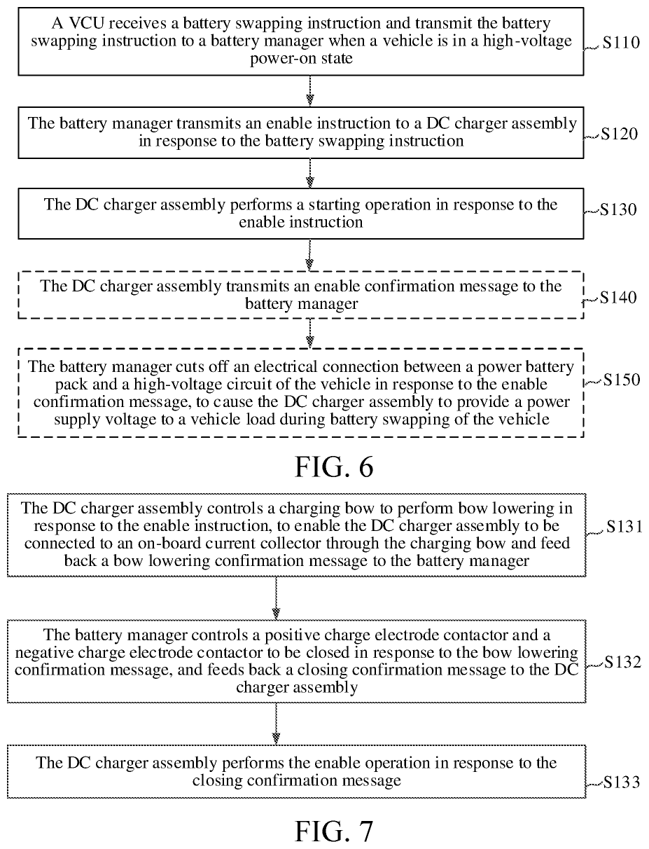

In order to better understand the battery swapping control process provided by the embodiment of the present disclosure, it is described in detail below with reference to FIG. 6 to FIG. 10.

FIG. 6 is a schematic flowchart of a battery swapping control method according to an embodiment of the present disclosure. The method is applicable to a vehicle, and the vehicle is configured with a circuit structure as shown in FIG. 1 to FIG. 5. The method specifically includes the following.

S110: A VCU receives a battery swapping instruction and transmit the battery swapping instruction to a battery manager when the vehicle is in a high-voltage power-on state.

S120: The battery manager transmits an enable instruction to a DC charger assembly in response to the battery swapping instruction.

S130: The DC charger assembly performs a starting operation in response to the enable instruction.

Specifically, the vehicle is in a high-voltage power-on state, that is, in a case that the VCU determines that the vehicle is currently in a power-on state, when the battery swapping operation requires to be performed, a current power battery pack requires to be removed and connected to a new power battery pack after charging. In this way, a user may input a battery swapping instruction to the VCU by operating a control panel. After the battery swapping instruction is acquired, the VCU may transmit the battery swapping instruction to the battery manager in response to the battery swapping instruction.

After battery swapping instruction is received, the battery manager may transmit the enable instruction to the DC charger assembly in response to the battery swapping instruction. After receiving the enable instruction, the DC charger assembly may perform the starting operation in response to the enable instruction, so that the voltage is outputted after the DC charger assembly is started. In other words, the power supply voltage is provided to the vehicle load to supply power to the vehicle load, so as to realize the power supply for seamless switching to the vehicle load and ensure that the vehicle load always maintains an operating state. In other words, during battery swapping of the vehicle, the battery manager is configured to cut off an electrical connection between the power battery pack and a high-voltage circuit of the vehicle, and the DC charger assembly is configured to provide a power supply voltage to the vehicle load.

It may be understood that, in an embodiment of the present disclosure, at the beginning of performing the above method, the vehicle is in the high-voltage power-on state, so that the power supply voltage can be supplied to the vehicle load through enabling of the DC charger assembly before cutting off the high-voltage electrical connection. Based on ensuring the normal operation of the normal load, by cutting off the electrical connection between the power battery pack and the high-voltage circuit, the vehicle is in the high-voltage safe state, and then the battery swapping operation is performed to ensure the high-voltage safety of the battery swapping and maintain the normal operation of the normal load.

It may be further understood that when the method is performed, after the battery swapping instruction is acquired in the high-voltage power-on state, the VCU may block a vehicle traction. In this way, when the battery swapping is performed subsequently, due to the traction blocking of the vehicle, safety of the battery swapping is ensured. After the battery swapping is completed, the VCU may lift the traction blockade.

In addition, when it is determined by the VCU that the vehicle is currently in an unpowered state and requires to perform the battery swapping operation, the battery swapping operation can be performed directly without requiring engagement of the battery manager and the DC charger assembly.

In an embodiment of the present disclosure, the power supply voltage may be supplied to the vehicle load by using the enable operation of the DC charger assembly. After connection between the power battery pack and the high-voltage circuit of the vehicle is cut off, the normal power supply of the vehicle load is still maintained. As a result, the normal operation of the load is realized during battery swapping, and user experience is improved.

Further, after the DC charger assembly is enabled in response to the enable instruction to successfully complete the power supply to the vehicle load, the enable confirmation message that the DC charger assembly is enabled may be fed back to the battery manager, so that the battery manager may perform a shutdown operation between the power battery pack and the high-voltage circuit in response to the enable confirmation message, to disconnect the power battery pack from the high-voltage circuit of the vehicle.

As shown in FIG. 6, the method may further include the following steps.

S140: The DC charger assembly transmits an enable confirmation message to the battery manager.

S150: The battery manager cuts off an electrical connection between the power battery pack and the high-voltage circuit of the vehicle in response to the enable confirmation message.

Specifically, after the battery manager receives the enable confirmation message, it indicates that the DC charger assembly may normally supply power to the vehicle load, that is, the battery swapping preparation is done. As a result, after the enable confirmation message is received, the battery manager performs the disconnection operation of the high-voltage circuit in response to the enable confirmation message, and cuts off the electrical connection between the power battery pack and the high-voltage circuit of the vehicle. In this way, when the subsequent battery swapping is performed, the vehicle is in the high-voltage safe state.

For example, as shown in FIG. 1 and FIG. 4, after receiving the boost confirmation message, the battery manager disconnects the positive and negative discharge electrode contactors (KM1 and KM2) of a power battery pack, and the positive and negative discharge electrode contactors (KM3 and KM4) of a main circuit.

It may be understood that after the above operation is completed, the battery swapping operation may be performed, that is, the vehicle is swapped with the new battery.

Optionally, in the embodiment of the present disclosure, when the DC charger assembly performs the enable operation, as shown in FIG. 7, the following steps are included.

S131: The DC charger assembly controls a charging bow to perform bow lowering in response to the enable instruction, to enable the DC charger assembly to be connected to an on-board current collector through the charging bow and feed back a bow lowering confirmation message to the battery manager.

S132: The battery manager controls a positive charge electrode contactor and a negative charge electrode contactor to be closed in response to the bow lowering confirmation message, and feeds back a closing confirmation message to the DC charger assembly.

S133: The DC charger assembly performs the enable operation in response to the closing confirmation message.

Specifically, when the DC charger assembly engages with the battery manager to perform the enable operation, the DC charger assembly may first control the charging bow to perform bow lowering in response to the enable instruction, to enable the DC charger assembly to be connected to the current collector of the vehicle through the charging bow.

In addition, after the connection is completed, a bow lowering confirmation message may be fed back to the battery manager through the wireless communication or the wired communication to indicate that the DC charger assembly is ready for battery swapping.

After the bow lowering confirmation message is received, the battery manager may control the positive charge electrode contactor and the negative charge electrode contactor in a closed-circuit structure in response to the bow lowering confirmation message, so that the DC charger assembly is in communication with the power supply circuit of the vehicle load, such as the positive and negative charge electrode contactors shown in FIG. 1.

Further, after the closing operation is completed, the closing confirmation message may be fed back to the DC charger assembly, indicating that the battery manager is currently ready for battery swapping. As a result, after the closing confirmation message is received, the DC charger assembly may perform an enable operation to provide the power supply voltage to the vehicle load, so that the vehicle load may operate normally.

Further, in the embodiment of the present disclosure, in order to improve user experience and the vehicle load maintains a constant output power during battery swapping. When the DC charger assembly performs an enable operation to supply power to the vehicle load, the enable may be performed based on a current total voltage of a to-be-swapped power battery pack.

Optionally, after the battery swapping instruction transmitted by the VCU or the bow raising confirmation message fed back by the DC charger assembly is received, the battery manager may acquire the current total voltage of the power battery pack, and transmit the total voltage to the DC charger assembly.

For example, when a closing confirmation message is transmitted to the DC charger assembly, the closing confirmation message may be caused to carry the total voltage, so that the DC charger assembly obtains the current total voltage of the power battery pack.

Alternatively, when the enable instruction is transmitted to the DC charger assembly, the enable instruction may be caused to carry the total voltage, so that the DC charger assembly obtains the current total voltage of the power battery pack.

Further, when the DC charger assembly performs the enable operation in response to the closing confirmation message, a boost mode is enabled by using the current total voltage of the power battery pack as the target value, so that the DC charger assembly is started with a constant voltage source to input a constant voltage to the vehicle load, and the input voltage value is close to the current total voltage of the power battery pack, thereby ensuring a stable operation of the vehicle load during the battery swapping and further enhancing user experience.

It may be understood that by maintaining the constant voltage output by using the current total voltage of the battery pack as the target value, based on seamlessly switching the power supply mode for the vehicle load, an impulse current may not exist when the BMM is controlled to disconnect the positive and negative discharge electrode contactors (KM1 and KM2) of the power battery pack, and the positive and negative discharge electrode contactors (KM3 and KM4) of the main circuit.

It may be understood that, in an embodiment of the present disclosure, when the battery manager disconnects connection between the power battery pack and the high-voltage circuit through the above operation and the DC charger assembly stably input a voltage to the vehicle load with a constant voltage source, the user may perform the battery swapping operation. That is to say, the user may remove the current power battery pack and connect the new power battery pack that has been charged to the vehicle.

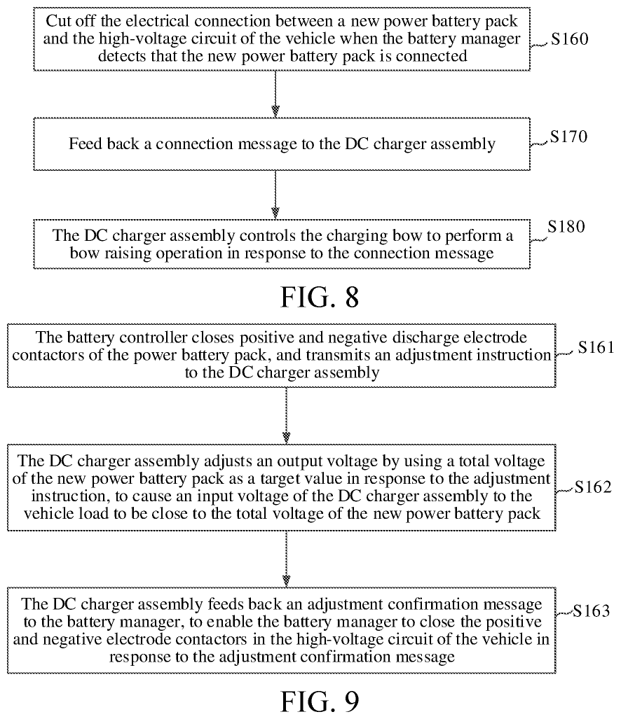

Further, as shown in FIG. 8, when the new power battery pack is connected to the vehicle, in order to ensure that the vehicle is normally powered on, the method may further include the following.

S160: The electrical connection between a new power battery pack and the high-voltage circuit of the vehicle is cut off when the battery manager detects that the new power battery pack is connected.

S170: A connection message is fed back to the DC charger assembly.

S180: The DC charger assembly controls the charging bow to perform a bow raising operation in response to the connection message.

Specifically, after the battery manager detects the new power battery pack when the user connects the new power battery pack to the vehicle, the contactor in the circuit may be controlled to close the contactor between the power battery pack and the high-voltage circuit. In this way, the power battery pack is connected to the high-voltage circuit of the vehicle, ensuring that the new power battery pack successfully supplies power to the vehicle load.

In this case, the battery manager may feed back the connection message of the new power battery pack to the DC charger assembly. After the DC charger assembly receives the connection message, it indicates that the battery swapping is completed. In response to the connection message, the voltage output may be stopped, the charging bow is controlled to perform bow raising, and the charging bow may be controlled to disconnect the DC charger assembly from the on-board current collector.

Optionally, in an embodiment of the present disclosure, when the battery manager detects a new power battery pack, the battery manager may detect the connection of the new power battery pack at a preset frequency, and when the connection of the new power battery pack is detected, the confirmation message can be fed back to the VCU.

Alternatively, it is also possible to trigger the battery manager to successfully detect the new power battery pack access by means of manual operation by the user. For example, by setting a button or the like, a signal for the connection of the new power battery pack is entered into the battery manager.

Further, after the DC charger assembly completes a charging bow raising operation, a bow raising confirmation message may be fed back to the battery manager. The battery manager may transmit a battery swapping completion confirmation message to the VCU in response to the bow raising confirmation message to indicate that the battery swapping is complete. After the confirmation message is received, the VCU may release a traction blockade and end the battery swapping method.

Optionally, as shown in FIG. 9, in an embodiment of the present disclosure, to ensure stability of the voltage output before and after the battery swapping during battery swapping and the vehicle load always maintains stable operation and ensures user experience, the battery manager may synchronously transmit the total voltage of the collected new power battery pack when the connection message is transmitted to the DC charger assembly, even if the total voltage of the new power battery pack is included in the connection message.

After the DC charger assembly receives the connection message carrying the current total voltage of the new power battery pack, a specific method of performing the bow raising operation may include the following.

S161: The battery controller closes positive and negative discharge electrode contactors of the power battery pack, and transmits an adjustment instruction to the DC charger assembly.

S162: The DC charger assembly adjusts the output voltage by using the total voltage of the new power battery pack as the target value in response to the adjustment instruction, to cause the input voltage of the DC charger assembly to the vehicle load to be close to the total voltage of the new power battery pack.

S163: The DC charger assembly feeds back an adjustment confirmation message to the battery manager, to enable the battery manager to close the positive and negative electrode contactors in the high-voltage circuit of the vehicle in response to the adjustment confirmation message.

Specifically, the positive and negative discharge electrode contactors of the new power battery pack may be closed when the battery manager detects that the new power battery pack is connected. In addition, the total voltage of the new power battery pack is acquired to transmitted the total voltage to the DC charger assembly. In other words, after the closing operation is completed and the total voltage of the new power battery pack is acquired, an adjustment instruction including the total voltage may be generated. Further, the adjustment instruction is transmitted to the DC charger assembly through the wireless manner, so that the DC charger assembly adjusts the output voltage by using the total voltage of the new power battery pack as the target value before controlling the bow raising. As a result, the input voltage of the DC charger assembly to the vehicle load is close to the total voltage of the new power battery pack, to ensure that the positive and negative electrode contactors in the high-voltage circuit of the vehicle are closed in the battery manager, to maintain the stable operation of the vehicle load, and to avoid the current impact.

Further, after the output voltage adjustment of the DC charger assembly is completed, the adjustment confirmation message may be fed back to the battery manager, indicating that the new power battery pack may be connected to the high-voltage circuit of the vehicle. As a result, after the adjustment confirmation message is received, the battery manager may close the contactor before the power battery pack and the high-voltage circuit in response to the adjustment confirmation message, and close the communication between the power battery pack and the high-voltage circuit. In other words, the positive and negative contactors in the high-voltage circuit of the vehicle are controlled to perform close.

It may be understood that, in an embodiment of the present disclosure, after detecting that the new power battery pack is connected, the battery manager may first perform control to close the positive and negative discharge electrode contactors of the battery pack, so that the new power battery pack is connected to the vehicle. In addition, in the subsequent operation, after the voltage adjustment of the DC charger assembly is completed, the new power battery pack may be connected to the high-voltage circuit of the vehicle.

For example, when the battery manager detects the new power battery pack, the positive and negative discharge electrode contactors (KM1 and KM2) of the new battery pack may be controlled to close. Further, the total voltage of the new power battery pack acquired from the battery manager is transmitted to the DC charger assembly. The DC charger assembly adjusts the output voltage by using the total voltage of the new power battery pack as the target value. Further, after the adjustment is successful, the DC charger assembly transmits the adjustment confirmation message that the battery swapping is ready to be connected to the battery manager. After the mode adjustment confirmation message is received, the battery manager performs control to close the positive and negative discharge electrode contactors (KM3 and KM4) of the main circuit.

Further, as shown in FIG. 8, after the entire high-voltage circuit is connected, that is, after the vehicle is powered on with the new power battery pack, a power-on confirmation message is fed back to the DC charger assembly through the battery manager, that is, the connection message. The DC charger assembly controls the charging bow to perform bow raising in response to the connection message, and completes the battery swapping operation.

Further, it may be understood that after completing the above battery swapping operation, that is, the vehicle is powered on again, and after the DC charger assembly controls the charging bow to perform bow raising, it means that the vehicle can travel normally. The VCU may release the traction operation and the method ends.

It may be understood that, in an embodiment of the present disclosure, after the new power battery pack is swapped, before the DC charger assembly controls the charging bow to perform bow lowering, the output voltage is adjusted based on the current total voltage of the new power battery pack as the target value, so that an impulse current does not exist when the battery manager closes the positive and negative discharge electrode contactors of the main circuit.

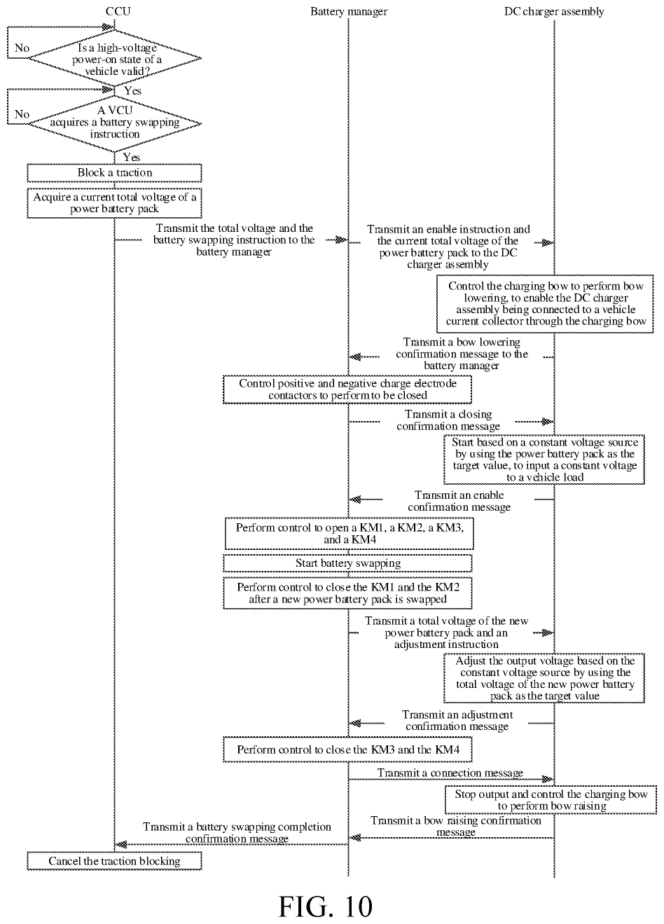

In order to better understand the battery swapping control process provided by the embodiment of the present disclosure, it is described in detail below with reference to FIG. 10.

As shown in FIG. 10, it is determined by the VCU whether the vehicle is in the high-voltage power-on state. When the vehicle is in the high-voltage power-on state, the battery swapping instruction inputted by the user is acquired, and after the battery swapping instruction is acquired, the VCU blocks the traction of the vehicle.

Further, the VCU can transmit the battery swapping instruction to the battery manager. The battery manager acquires the current total voltage of the power battery pack. The enable instruction and the current total voltage of the battery pack are transmitted to the DC charger assembly through Wi-Fi.

After the enable instruction is received, the DC charger assembly may control the charging bow to perform bow lowering in response to the enable instruction, so as to connect with the vehicle current collector, and provide the power supply voltage to the vehicle load in a constant voltage manner. In addition, the DC charger assembly transmits the bow lowering confirmation message to the battery manager through Wi-Fi to indicate that the battery swapping is ready.

After the bow lowering confirmation message indicating that the power change is ready transmitted by the DC charger assembly is received, in response to the bow lowering confirmation message, the battery manager performs control to close the positive and negative charge electrode contactor of a power battery pack, and feeds back to the DC charger assembly a closing confirmation message indicating that battery swapping is ready.

After the closing confirmation message transmitted by the BMM is received, the DC charger assembly starts, based on the constant voltage source by using the current total voltage of the power battery pack as the target value, to input a constant voltage to the vehicle load. In addition, after the startup is completed, the DC charger assembly feeds back an enable confirmation message to the battery manager to indicate that battery swapping is ready.

Further, after the enable confirmation message is received, the battery manager may perform control to close the positive and negative discharge electrode contactors (KM3 and KM4) of the main circuit and the positive and negative discharge electrode contactors (KM1 and KM2) of the power battery pack in response to the enable confirmation message.

In this case, the user may start the battery swapping, that is, the current power battery pack is removed and swapped with a new power battery pack that has been charged.

Further, after the new power battery pack is connected, the battery manager may perform control to close to the positive and negative discharge electrode contactors (KM1 and KM2) of the power battery pack and transmit an adjustment instruction including the total voltage of the new battery to the DC charger assembly.

As a result, after the total voltage of the new battery transmitted by the BMM is received, the DC charger assembly may adjust the output voltage based on the constant voltage source by using the total voltage of the new battery pack as the target value.

After the DC charger assembly completes the output voltage adjustment, the adjustment confirmation message may be fed back to the battery manager to indicate that the battery connection is ready. After the adjustment confirmation message transmitted by the charger is received, the BMM may perform control to close the positive and negative discharge electrode contactors (KM3 and KM4) of the main circuit and feed back the connection message to the DC charger assembly.

Further, after the connection message is received, the DC charger assembly may stop outputting a voltage and control perform bow raising. Then, the bow raising confirmation message indicating completion of battery swapping is fed back to the battery manager. In this way, the battery manager may transmit the confirmation message indicating completion of battery swapping to the VCU after the bow raising confirmation message transmitted by the DC charger assembly is received.

Finally, after the confirmation message transmitted by the battery manager is received, the VCU may release the traction blockade in response to the confirmation message, and the method ends.

It may be understood that, in an example of the present disclosure, when the vehicle battery swapping is performed in the high-voltage power-on state, the DC charger assembly uses the current total voltage of the power battery pack to be swapped as the target value, and inputs a constant voltage to the vehicle load, to ensure that the stable operation of the vehicle load is maintained after the power battery pack is disconnected from the high-voltage circuit of the vehicle. In addition, after the new power battery pack is successfully swapped, the DC charger assembly adjusts the output voltage by using the current total voltage of the new power battery pack as the target value before stopping the voltage output. In this way, the impulse current does not exist when the BMM control closes the positive and negative discharge electrode contactors of the main circuit, which realizes the high-voltage safety of the battery swapping operation, maintains the continuous stable operation of the vehicle load, and improves user experience.

According to another aspect, an embodiment of the present disclosure further provides a vehicle. The vehicle is loaded with the circuit structure shown in FIG. 1 to FIG. 5, and the electrical device in the structure is shown in FIG. 6 to achieve an electrical connection.

During a power-on operation of the vehicle, that is, the vehicle is in the high-voltage power-on state, and when the battery swapping is required, the battery swapping method described in the above embodiment can be used to perform the battery swapping. That is, when the battery swapping mode is entered, the DC charger assembly is connected to the circuit structure of the vehicle, which seamlessly switches the power supply mode for the vehicle load, and can output the voltage by using the current total voltage of the power battery pack to be swapped as the target value, so that the impulse current does not exist when the battery manager controls the positive and negative discharge electrode contactors of the power battery pack, and the positive and negative discharge electrode contactors of the main circuit to be opened. Further, after the new power battery pack is swapped, the DC charger assembly adjusts the output voltage based on the current total voltage of the new power battery pack as the target value, so that the impulse current does not exist when the battery manager controls close the positive and negative discharge electrode contactors of the new power battery pack, and the positive and negative discharge electrode contactors of the main circuit.

According to another aspect, an embodiment of the present disclosure further provides processing device. The processing device includes a memory, a processor, and a computer program stored on the memory and running on the processor. The processor is configured to realize the method for controlling battery swapping of a vehicle described in the above embodiment when performing the program.

The processing device may be an integrated circuit configured in the VCU, the battery manager, or the DC charger assembly.

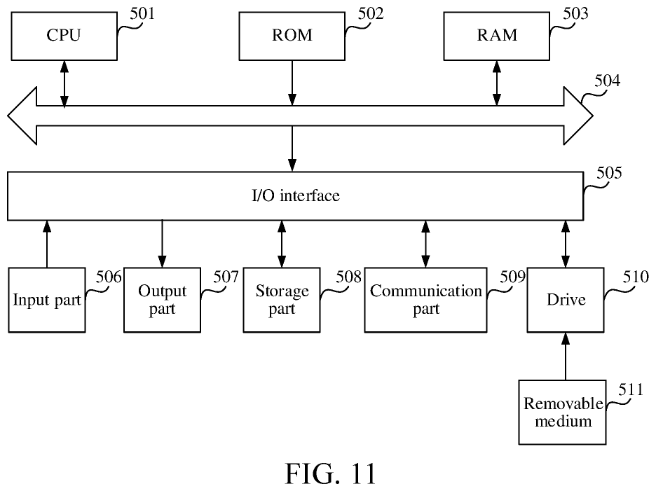

Reference is made below to FIG. 11. FIG. 11 is a schematic structural diagram of a computer electronic device of a processing device according to an embodiment of the present disclosure.

As shown in FIG. 11, the computer electronic device 500 includes a central processing unit (CPU) 501, which can perform various appropriate actions and processing according to a program stored in a read-only memory (ROM) 502 or a program loaded into a random access memory (RAM) 503 from a storage part 502. The RAM 503 further stores various programs and data required for the operation of the computer electronic device 500. The CPU 501, the ROM 502, and the RAM 503 are connected to each other through a bus 504. An input/output (I/O) interface 505 is also connected to the bus 504.

The following components are connected to the I/O interface 505: an input part 506 including a keyboard and a mouse; an output part 507 including a cathode ray tube (CRT), a liquid crystal display (LCD), a loudspeaker, and the like; a storage part 508 including a hard disk; and a communication part 509 including a network interface card such as an LAN card or a modem and the like. The communication part 509 performs communication processing by using a network such as the Internet. A driver 510 is also connected to the I/O interface 505 as required. A removable medium 511, such as a magnetic disk, an optical disc, a magneto-optical disk, or a semiconductor memory, is installed on the drive 510 as required, so that a computer program read from the removable medium is installed into the storage part 508 as required.

Particularly, according to an embodiment of the present disclosure, the processes described in the following by referring to the flowcharts may be implemented as computer software programs. For example, the embodiments of the present disclosure include a computer program product, including a computer program carried on a machine-readable medium. The computer program includes program code for performing the method shown in the flowchart. In such an embodiment, the computer program may be downloaded and installed from a network through the communication part 509, and/or installed from the removable medium 511. When the computer program is executed by the central processing unit (CPU) 501, the above functions defined in the electronic device of the present disclosure are performed.

It should be noted that the computer-readable medium according to the present disclosure may be a computer-readable signal medium or a computer-readable storage medium or any combination of the two media. The computer-readable storage medium may be, for example, but is not limited to, an electric, magnetic, optical, electromagnetic, infrared, or semi-conductive electric device, apparatus, or component, or any combination of the above. More specific examples of the computer-readable storage medium may include, but are not limited to: an electrical connection by one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical memory device, a magnetic storage device or any appropriate combination thereof. In the present disclosure, the computer-readable storage medium may be any tangible medium including or storing a program, and the program may be used by or in combination with an instruction execution electronic device, apparatus, or device. In the present disclosure, the computer readable signal medium may be a data signal included in a baseband or propagated as a part of a carrier, in which computer readable program code is carried. A data signal propagated in such a way may assume multiple forms, including, but not limited to, an electromagnetic signal, an optical signal, or any appropriate combination thereof. The computer-readable signal medium may be further any computer-readable medium in addition to a computer-readable storage medium. The computer-readable medium may be used for sending, propagating, or transmitting a program used by or in combination with an instruction execution electronic device, apparatus, or device. The program code included in the computer-readable medium may be transmitted by using any suitable medium, including but not limited to, wireless transmission, a wire, a cable, radio frequency (RF) or the like, or any other suitable combination thereof.

Flowcharts and block diagrams in the drawings illustrate architectures, functions, and operations that may be implemented by using the processing device, the method, and the computer program product according to the various embodiments of the present disclosure. In this regard, each box in a flowchart or a block diagram may represent a module, a program segment, or a part of code. The module, the program segment, or the part of code includes one or more executable instructions used for implementing designated logic functions. In some implementations used as substitutes, functions annotated in boxes may alternatively occur in a sequence different from that annotated in an accompanying drawing. For example, two boxes shown in succession may be performed basically in parallel, and sometimes the two boxes may be performed in a reverse sequence. This is determined by a related function. It should also be noted that, each box in a block diagram and/or a flowchart and a combination of boxes in the block diagram and/or the flowchart may be implemented by using a dedicated hardware-based electronic device configured to perform a specified function or operation, or may be implemented by using a combination of dedicated hardware and a computer instruction.

The units or modules described in the embodiments of the present disclosure may be implemented in software or hardware. The described units or modules may be provided in a processor, for example, may be described as a processor, including a receiving module and a starting module. Names of the units or modules do not constitute a limitation on the units or modules in a specific case. For example, the starting module may also be described as “for the DC charger assembly to perform a starting operation in response to the enable instruction, so that after the electrical connection between the power battery pack and the high-voltage circuit of the vehicle is cut off during battery swapping of the vehicle, a voltage is inputted to the vehicle load”.

In another aspect, the present disclosure further provides a computer-readable storage medium. The computer-readable storage medium may be included in the electronic device described in the above embodiments, or may exist alone without being assembled into the electronic device. The computer-readable storage medium described above stores one or more programs, when the above programs are used by one or more processors to execute the method for controlling battery swapping of a vehicle described in the present disclosure.

According to the method and the system for controlling battery swapping, and the vehicle provided by embodiments of the present disclosure, when the vehicle replaces the power battery pack in the high-voltage power-on state, the DC charger assembly is connected to the vehicle load by controlling starting the DC charger assembly, to ensure that the normal power supply of the vehicle load is still maintained after the electrical connection between the vehicle power battery pack and the high-voltage circuit is cut off during battery swapping. As a result, the normal operation of the vehicle load during battery swapping of a vehicle is realized, and user experience is improved.

The above description is merely a preferred embodiment of the present disclosure and a description of the technical principles that are used. A person skilled in the art should understand that the scope of the present disclosure is not limited to the technical solutions formed by the specific combination of the above technical features, but also covers other technical solutions formed by any combination of the above technical features or their equivalent features without departing from the concept of the present disclosure, for example, the technical solutions formed by replacing the above features with (but not limited to) technical features with similar functions disclosed in the present disclosure.

What is claimed is:

1. A method for controlling battery swapping of a vehicle, the vehicle comprising a vehicle control unit (VCU), a power battery pack, a vehicle load, and a battery manager, the power battery pack being configured to supply power to the vehicle load, and the method comprising:
receiving, by the VCU, a battery swapping instruction and transmitting the battery swapping instruction to the battery manager when the vehicle is in a high-voltage power-on state;
transmitting, by the battery manager, an enable instruction to a direct current (DC) charger assembly in response to the battery swapping instruction, the DC charger assembly being arranged on the ground and configured to communicate with the battery manager;
performing, by the DC charger assembly, a starting operation in response to the enable instruction; and
cutting off, by the battery manager, an electrical connection between the power battery pack and a high-voltage circuit of the vehicle, and providing, by the DC charger assembly, a power supply voltage to the vehicle load.

2. The method for controlling battery swapping of a vehicle according to claim 1, before the cutting off an electrical connection between the power battery pack and a high-voltage circuit of the vehicle, the method further comprising:
receiving, by the battery manager, an enable confirmation message transmitted by the DC charger assembly.

3. The method for controlling battery swapping of a vehicle according to claim 1, wherein the performing, by the DC charger assembly, a starting operation in response to the enable instruction comprises:
controlling, by the DC charger assembly, a charging bow to perform bow lowering in response to the enable instruction, to enable the DC charger assembly to be connected to an on-board current collector through the charging bow and feed back a bow lowering confirmation message to the battery manager;
controlling, by the battery manager, a positive charge electrode contactor and a negative charge electrode contactor to be closed in response to the bow lowering confirmation message, and feeding back a closing confirmation message to the DC charger assembly; and
performing, by the DC charger assembly, the starting operation in response to the closing confirmation message.

4. The method for controlling battery swapping of a vehicle according to claim 3, wherein the enable instruction comprises a current total voltage of the power battery pack, and the performing, by the DC charger assembly, the starting operation in response to the closing confirmation message comprises:
performing, by the DC charger assembly, the starting operation by using the current total voltage of the power battery pack as a target value, to cause the power supply voltage provided by the DC charger assembly to the vehicle load to be close to the current total voltage of the power battery pack.

5. The method for controlling battery swapping of a vehicle according to claim 2, wherein the performing, by the DC charger assembly, a starting operation in response to the enable instruction comprises:
controlling, by the DC charger assembly, a charging bow to perform bow lowering in response to the enable instruction, to enable the DC charger assembly to be connected to an on-board current collector through the charging bow and feed back a bow lowering confirmation message to the battery manager;
controlling, by the battery manager, a positive charge electrode contactor and a negative charge electrode contactor to be closed in response to the bow lowering confirmation message, and feeding back a closing confirmation message to the DC charger assembly; and
performing, by the DC charger assembly, the starting operation in response to the closing confirmation message.

6. The method for controlling battery swapping of a vehicle according to claim 5, wherein the enable instruction comprises a current total voltage of the power battery pack, and the performing, by the DC charger assembly, the starting operation in response to the closing confirmation message comprises:
performing, by the DC charger assembly, the starting operation by using the current total voltage of the power battery pack as a target value, to cause the power supply voltage provided by the DC charger assembly to the vehicle load to be close to the current total voltage of the power battery pack.

7. The method for controlling battery swapping of a vehicle according to claim 2, wherein the cutting off, by the battery manager, an electrical connection between the power battery pack and a high-voltage circuit of the vehicle in response to the enable confirmation message comprises:
disconnecting positive and negative discharge electrode contactors of the new power battery pack and positive and negative electrode contactors in the high-voltage circuit of the vehicle.

8. The method for controlling battery swapping of a vehicle according to claim 3, wherein the cutting off, by the battery manager, an electrical connection between the power battery pack and a high-voltage circuit of the vehicle in response to the enable confirmation message comprises:
disconnecting positive and negative discharge electrode contactors of the new power battery pack and positive and negative electrode contactors in the high-voltage circuit of the vehicle.

9. The method for controlling battery swapping of a vehicle according to claim 4, wherein the cutting off, by the battery manager, an electrical connection between the power battery pack and a high-voltage circuit of the vehicle in response to the enable confirmation message comprises:
disconnecting positive and negative discharge electrode contactors of the new power battery pack and positive and negative electrode contactors in the high-voltage circuit of the vehicle.

10. The method for controlling battery swapping of a vehicle according to claim 5, wherein the cutting off, by the battery manager, an electrical connection between the power battery pack and a high-voltage circuit of the vehicle in response to the enable confirmation message comprises:
disconnecting positive and negative discharge electrode contactors of the new power battery pack and positive and negative electrode contactors in the high-voltage circuit of the vehicle.

11. The method for controlling battery swapping of a vehicle according to claim 6, wherein the cutting off, by the battery manager, an electrical connection between the power battery pack and a high-voltage circuit of the vehicle in response to the enable confirmation message comprises:
disconnecting positive and negative discharge electrode contactors of the new power battery pack and positive and negative electrode contactors in the high-voltage circuit of the vehicle.

12. The method for controlling battery swapping of a vehicle according to claim 3, further comprising:
cutting off the electrical connection between a new power battery pack and the high-voltage circuit of the vehicle when the battery manager detects that the new power battery pack is connected, and
transmitting a connection message to the DC charger assembly; and
controlling, by the DC charger assembly, the charging bow to perform bow raising in response to the connection message.

13. The method for controlling battery swapping of a vehicle according to claim 4, further comprising:
cutting off the electrical connection between a new power battery pack and the high-voltage circuit of the vehicle when the battery manager detects that the new power battery pack is connected, and
transmitting a connection message to the DC charger assembly; and
controlling, by the DC charger assembly, the charging bow to perform bow raising in response to the connection message.

14. The method for controlling battery swapping of a vehicle according to claim 5, further comprising:
cutting off the electrical connection between a new power battery pack and the high-voltage circuit of the vehicle when the battery manager detects that the new power battery pack is connected, and
transmitting a connection message to the DC charger assembly; and
controlling, by the DC charger assembly, the charging bow to perform bow raising in response to the connection message.

15. The method for controlling battery swapping of a vehicle according to claim 6, further comprising:
cutting off the electrical connection between a new power battery pack and the high-voltage circuit of the vehicle when the battery manager detects that the new power battery pack is connected, and
transmitting a connection message to the DC charger assembly; and
controlling, by the DC charger assembly, the charging bow to perform bow raising in response to the connection message.

16. The method for controlling battery swapping of a vehicle according to claim 12, wherein the cutting off the electrical connection between a new power battery pack and the high-voltage circuit of the vehicle comprises:
closing, by the battery controller, the positive and negative discharge electrode contactors of the power battery pack, and transmitting an adjustment instruction to the DC charger assembly;
adjusting, by the DC charger assembly, a current output voltage of the new power battery pack in response to the adjustment instruction, and feeding back an adjustment confirmation message to the battery pack; and
controlling, by the battery manager, the positive and negative electrode contactors in the high-voltage circuit of the vehicle to be closed in response to the adjustment confirmation message.

17. The method for controlling battery swapping of a vehicle according to claim 16, wherein the connection message comprises the current total voltage of the new power battery pack, and the adjusting, by the DC charger assembly, a current output voltage of the new power battery pack in response to the connection message comprises:
adjusting, by the DC charger assembly, the output voltage by using the total voltage of the new power battery pack as the target value, to cause the power supply voltage provided to the vehicle load to be close to the total voltage of the new power battery pack.

18. The method for controlling battery swapping of a vehicle according to claim 16, after the controlling, by the DC charger assembly, the charging bow to perform bow raising, the method further comprising:
transmitting, by the DC charger assembly, a bow raising confirmation message to the battery manager; and
transmitting, by the battery manager, a confirmation message to the VCU in response to the bow raising confirmation message.

19. A system for controlling battery swapping of a vehicle, the system comprising a VCU, a DC charger assembly, a power battery pack, a vehicle load, and a battery manager, the power battery pack being configured to supply power to the vehicle load,
the VCU being configured to receive a battery swapping instruction and transmit the battery swapping instruction to the battery manager when the vehicle is in a high-voltage power-on state;
the battery manager being configured to receive the battery swapping instruction received by the VCU, and transmit an enable instruction to the DC charger assembly in response to the battery swapping instruction; the DC charger assembly being arranged on the ground and configured to communicate with the battery manager;
the DC charger assembly being configured to perform a starting operation in response to the enable instruction;
the battery manager being configured to cut off an electrical connection between the power battery pack and a high-voltage circuit of the vehicle; and the DC charger assembly being configured to provide a power supply voltage to the vehicle load.

20. A vehicle, configured with the system for controlling battery swapping according to claim 10, the vehicle being configured to perform the method for controlling battery swapping of a vehicle according to claim 1 during swapping of a power battery pack in a high-voltage power-on state.
